(19) United States
(12) Patent Application Publication
(10) Pub. No.: US 2005/0000632 A1
(43) Pub. Date: Jan. 6, 2005

(54) Method of bonding flat ribbon cables adhesively to substrates such as the interior decorative components of a passenger car, especially roof lining, door side part and boot lid

(75) Inventor: Matthias Von Samon-Himmelstjerna, Henstedt-Ulzburg (DE)

Correspondence Address: NORRIS, MCLAUGHLIN & MARCUS, PA, 875 THIRD STREET, 18TH FLOOR, NEW YORK, NY, 10022, US

(73) Assignee: tesa AG, Hamburg (DE)

(21) Appl. No.: 10/713,166

(22) Filed: Nov. 14, 2003

(30) Foreign Application Priority Data
May 23, 2003 (DE) 103 23 801.8
Aug. 1, 2003 (DE) 103 35 238.4

(51) Int. Cl. B32B 31/00

(52) U.S. Cl. 156/230

(57) ABSTRACT

Method of bonding flat ribbon cables adhesively to substrates such as the interior decorative components of a passenger car, especially roof lining, door side part or boot lid, which comprises inserting the flat ribbon cable into a mount to which the flat ribbon cable is temporarily fixed, applying double-sided adhesive tape sections to the flat ribbon cables, a relative movement taking place between the flat ribbon cable provided with the double-sided adhesive tape sections and the substrate with respect to one another, the double-sided adhesive tape sections adhesively bonding the flat ribbon cable to the substrate, so that when the mount is removed from the substrate the flat ribbon cable is detached from the mount.

The invention relates to a method of bonding flat ribbon cables adhesively to substrates such as the interior decorative components of a passenger car, especially roof lining, door side part and boot lid.

Parts which are to be fixed by means of a double-sided adhesive tape (for example flat ribbon cable, displays, cardboard packaging) are very often made completely self-adhesive beforehand. This entails a very high level of material consumption, and not only the even edging of parts with an adhesive tape but also the necessary removal of the adhesive tape liner later on, during assembly, are very time-consuming operations.

One alternative is to apply individual adhesive dots directly at the assembly stage, and then to bond the part to these dots subsequently. This operation, again, is inconvenient, since the adhesive dots are also provided with a liner which has to be removed beforehand.

Certain parts (for example electronic components or seals in mobile telephones) compel the use of double-sidedly adhesive diecuts, depending on application. These diecuts are individual sections of adhesive tape which either are arranged immediately following one another on a backing web or are located on the backing web at a given distance from one another, this distance being regular or irregular.

These diecuts must be converted to the required shape beforehand in a diecutting operation, particularly by what is known as the kiss-cut operation, in which case the tape which is made adhesive in order to produce the diecuts must be lined with an antiadhesive material beforehand.

The feature of the kiss-cut process is that, in the course of diecutting, the antiadhesive material is not, or not substantially, injured or cut into.

This prevents adhesive from the diecuts running into the incisions after the diecutting operation and sticking to the material. Were this to occur, the material could split in downstream production steps involving the further processing of the material with the diecuts. In that case the entire roll would be excluded from further processing and would therefore become waste.

Further applications of such double-sidedly adhesive diecuts are to be found in the automotive sector. One example which may be noted is the adhesive bonding of flat cables in the roof lining of passenger cars.

In contrast to conventional cable harnesses, laminated cable systems are thin, save on weight and space, and are very flexible but are difficult to manipulate, so that their manual assembly on a passenger car interior component is very complex and time-consuming.

To date the systems have been fastened by virtue of the application, in a first production step, of double-sided adhesive tapes with release paper to one side of FFC cable systems at the premises of the cable harness manufacturer.

In a second, later step, generally at the premises of the carmaker on the assembly line, the FFC cable harness is applied to the decorative component in a way which requires the release paper to be removed by hand before the cable system is positioned to its final site in the roof lining.

This operation is very time consuming and has the disadvantage, moreover, that it is not in accordance with the desire on the part of many automotive component manufacturers for greater automation. Furthermore, it requires manual work, with the risks of fluctuating quality levels.

It is an object of the invention to provide a method which, with a very simple construction, applies flat ribbon cable very efficiently and precisely, with high positional precision, to, for example, a passenger car component, and does so using a backing material web with double-sided adhesive tape sections and/or diecuts.

This object is achieved by means of a method as specified in the main claim. Developments of the methods of the invention are provided by the subclaims.

The invention accordingly provides a method of bonding flat ribbon cables adhesively to substrates such as the interior decorative components of a passenger car, especially roof lining, door side part or boot lid, which comprises
inserting the flat ribbon cable into a mount to which the flat ribbon cable is temporarily fixed,
applying double-sided adhesive tape sections to the flat ribbon cables,
a relative movement taking place between the flat ribbon cable provided with the double-sided adhesive tape sections and the substrate with respect to one another,
the double-sided adhesive tape sections adhesively bonding the flat ribbon cable to the substrate, so that when the mount is removed from the substrate the flat ribbon cable is detached from the mount.

The relative movement can be such that the mount with the flat ribbon cable is moved towards the substrate, or the other way round.

It is also possible for the mount and the flat ribbon cable to move towards one another at the same time.

The adhesive force of the adhesive tape sections is greater than the force holding the flat ribbon cable in the mount, so that the flat ribbon cable is sprung from the mount as soon as substrate and mount are removed from one another after the pressing operation.

In one advantageous embodiment the adhesive bonding of the double-sided adhesive tape sections to the flat ribbon cable takes place by means of an apparatus for unrolling a backing material web, present on a roll, with the double-sided adhesive tape sections, the said apparatus comprising
a handle fitted to a base plate,
a receiver mounted rotatably on the base plate and intended for the roll of backing material web,
a pressure roller which is mounted rotatably on the base plate and which during the dispensing operation brings the backing material web with the adhesive tape sections into contact with the substrate, and via which the backing material web with the adhesive tape sections is guided from the receiver for the roll in such a way that the adhesive tape sections are dispensed onto the substrate from the backing material web during the dispensing operation,
a drive roller which is mounted rotatably on the base plate and via which the backing material web with the adhesive tape sections is guided in such a way that the drive roller rotates synchronously with respect to the speed of the backing material web,
a receiving roller which is mounted rotatably on the base plate and which receives the backing material web after the adhesive tape sections have been dispensed, and which in particular is set in rotation via a belt by the movement of the drive roller.

In a another preferred embodiment the drive roller is disposed between the receiver for the roll of backing material web and the pressure roller.

In another preferred embodiment a guide roller is disposed between the receiver for the roll of backing material web and the drive roller, in order to produce a very high angle of wrap of the backing material web around the drive roller.

In this way, secure transmission of the movement of the backing material web to the drive roller and therefore, via the preferred belt, to the receiving roller is ensured.

With further preference on an axle which can be fixed on the handle there is an adjustable positioning aid, in particular in the form of a rotatable shaft which can be fixed by screwing, via which the backing material web is guided from the receiver for the roll of backing material web in the direction of the drive roller.

This positioning aid, composed in particular of a shaft which is to be guided movably in a groove, and which can be fixed at any desired position within the groove by screwing, serves to ensure, depending on the application of the adhesive tape sections, that the beginning and/or end of the adhesive tape sections, especially double-sided adhesive tape sections, is always at a predetermined position, so that the adhesive bond always begins in a defined manner at the beginning of an adhesive tape section with a length, for example, of 15 mm, and that after the dispensing operation, in other words when, for example, the apparatus has been drawn once over a section of the flat ribbon cable, the adhesive bond ends at the end of another adhesive tape section with a length, for example, of 15 mm.

Another possible exemplary solution for a positioning aid of this kind is an additional, small magnifying lens with marking, which can be positioned in the same way.

The distance between pressure roller and positioning aid is individually adjustable, in adaptation of the length of the double-sided adhesive tape sections.

By means of this positioning aid the user of the apparatus is always able to stay within the relationship determined by the length of the adhesive tape sections.

In order to make the apparatus easy to use for both left-handers and right-handers, the handle and all other components can be mounted in mirror-image form on the base plate.

A further preferred version in the receiver for the roll of backing material web is an adjustable brake, in particular a friction brake. This brake ensures a uniform tension, not too low, in the backing material web during the dispensing operation.

In another preferred embodiment one side of the pressure roller is fixed on the base plate and the other side carries a counterplate. In the case of the apparatus which is pushed during the dispensing operation, the counterplate and the base plate are of prolonged design in the direction of the handle. The counterplate and the base plate are harmonized in their shape with the pressure roller and with the lever arm of the handle, so that at the end of the dispensing operation the apparatus as a whole can easily be swivelled by the user about the fulcrum which arises from this geometry. As a result of this rotational movement, in conjunction with the positioning aid, on the one hand it is always possible to dispense the last adhesive tape section reliably, i.e. to transfer it from the backing material web for the substrate, while on the other hand the next adhesive tape section, not to be bonded until later, is still held securely on the backing material web.

Suitable materials for the components include plastics, although a metal version is also possible.

The apparatus for unrolling can in a further embodiment be moved not by a manual movement but by a standard automatic handling device. In this case it is preferred for a mechanical/electrical positioning aid, in addition to a customary optical/electric positioning aid, to be employed as follows:

The rotatable shaft which is adjustable in the groove possesses an additional shaft connected mechanically to it, in the form for example of a toothed wheel, which penetrates a free edge region of the backing material web that is not masked by the adhesive tape sections. As a result, the relationship once set manually, in other words the precise distance between positioning aid and pressure roller, can no longer be departed. A standard rotation sensor, fixed mechanically to the shaft of the toothed wheel, is then used to dry the automatic handing device, in other words to initiate beginning and end of the movement needed for the dispensing operation.

With preference, accordingly, the apparatus is guided by a robot, so that adhesive tape sections are applied to the flat ribbon cable at precisely predetermined locations.

With further advantage the mount of the laminated cable is designed in the form of a channel whose side walls enclose the edges of the flat ribbon cable in the manner of a bracket, so that the flat ribbon cable is fixed mechanically in the channel. The channel serves as a mounting device into which the laminated cable can be temporarily inserted and can be held in correct position, consisting of a rail which corresponds to the width of the laminated cable. In order to be able to hold the laminated cables in position, even upside down, they are preferably equipped at the sides with an area furnished by an adhesive tape, preferably a double-sided adhesive tape (for example an anti-slip tape such as tesa® 4863), which prevents the laminated adhesive tape slipping out of the channel while being swivelled into position over the definitive fastening site on the passenger car component. The channel (assembly lattice mechanism) is preferably, moreover, equipped on its base area with an adhesive-tape-coated anti-slip coating, so that during the furnishing of the laminated cable with adhesive tape by gun means the said cable cannot be moved lengthways on the channel.

The height of the side walls of the channel preferably corresponds approximately to the sum of the thickness of the flat ribbon cable, which is normally between 0.5 and 1 mm, and the thickness of the adhesive tape sections.

The apparatus is suitable for applying a multiplicity of backing materials which are present on a roll and on which self-adhesive tape sections and/or diecuts are present.

These diecuts are produced in a converting operation in which a double-sidedly adhesive tape is placed on the backing material and diecuts are punched out of the said tape, in particular in a kiss-cut operation.

The backing material web in question is preferably a web of backing material on which double-sidedly self-adhesive tape sections are disposed, an anti-adhesive coating being applied to both sides of the backing material web, and the two anti-adhesive coatings differing in their degree of their repellency towards the adhesive of the adhesive tape sections.

In one advantageous embodiment the anti-adhesive coating located on the top face of the backing material web has a lower repellency than the anti-adhesive coating located on the bottom face of the backing material.

When the backing material web is in its unrolled state, the adhesive tape sections are on its top face.

This ensures that
the individual adhesive tape sections can be converted and made available on the backing material web in the form of a roll without further auxiliary means (for example a second lining); during the converting operation (cutting-to-size of the adhesive tape sections) the superfluous material can be taken off as a lattice network and discarded, and
the adhesive tape sections can be dispensed easily by means of the apparatus of the invention.

As backing material web it is preferred to use paper, a paper/polyolefin composite and/or a film.

Suitable backing materials further include, in principle, films such as, for example, BOPP or MOPP, PET, PVC or nonwovens (based on cellulose or polymers). Also suitable are foams (for example PU, PE, PE/EVA, EPDM, PP, PE, silicone, etc.) or release papers (kraft papers, polyolefin-coated papers) or release films (PET, PP or PE or combinations of these materials) as coating substrates.

As the anti-adhesive coating it is preferred to use a solventlessly coated silicone.

With further preference the anti-adhesive coating and/or solventlessly coated silicone is applied at from 0.8 to 3.7 g/m², preferably from 1.3 to 3.2 g/m², very preferably from 1.8 to 2.8 g/m².

Solventborne systems, however, are also possible as anti-adhesive coating, at an application rate in particular of from 0.3 to 1 g/m².

Materials used additionally as backings for the adhesive tape sections are preferably web-form materials such as paper, nonwovens, polymeric films, and foams.

All kinds of double-faced adhesive tapes are suitable in principle as base material for the adhesive tape sections.

As adhesives for the adhesive tapes it is possible to use all pressure-sensitive adhesives such as are mentioned, for example, in SATAS, Handbook of Pressure Sensitive Adhesive Technology, Third Edition. Particularly suitable are natural/synthetic rubber-based and acrylate-based adhesives which can be applied from the melt or solution.

In accordance with the invention it is further possible as backing material to use highly compacted glassine papers provided with a polymeric coating on the top and/or bottom side, an anti-adhesive layer, in particular a silicone coating, having been applied to at least one of the two polymeric coatings present where appropriate.

In a further embodiment of the invention a paper backing material with a density of from 1.1 to 1.25 g/cm³ is used, the paper backing essentially having a top side and a bottom side.

On the top and/or bottom side the paper backing is provided with a polymeric coating, an anti-adhesive layer having been applied at least to one of the two polymeric coatings present where appropriate.

The paper backing or glassine paper preferably has a density of from 1.12 to 1.2 g/cm³, in particular from 1.14 to 1.16 g/cm³.

With further preference the paper backing or glassine paper has a basis weight of from 40 to 120 g/m², preferably from 50 to 110 g/m², very preferably from 60 to 100 g/m².

Polymers used for the polymeric coating include in particular polyolefins such as LDPE, HDPE, blends of these two, for example MDPE, PP or PET. LDPE is especially advantageous.

The poly-coated sides of the LDPE or HDPE paper backing can also be produced so as to be matt or glossy.

With further preference the polymeric coating is applied at from 5 to 30 g/m², preferably from 10 to 25 g/m², very preferably from 15 to 20 g/m².

In the case of polyester, in particular, application may also take place at just from 2 to 3 g/m².

Furthermore, one outstanding development of the invention is the use as anti-adhesive layers of, for example, silicone, paraffin, Teflon or waxes. In that case it is possible to use silicone-free release layers, for example “non Silicone” from Rexam, or low-silicone release layers, for example “Lo ex” from Rexam.

Depending on the application of the paper backing material it is possible to give the anti-adhesive layers the same or different release qualities on either side of the backing material, hence including the possibility of setting different release properties on either side (controlled release).

In this way it is ensured that, in the case of a poly-coating on both sides, the liner material exhibits
dimensional stability properties (good flatness)
a low thickness with high consistency of thickness (narrow tolerances, more precise diecuts)
and a layer which protects against diecutting into the body of the paper
   or that, in the case of poly-coating on one side, the liner material exhibits
a low thickness with high consistency of thickness (narrow tolerances, more precise diecuts) and
a layer which protects against diecutting into the body of the paper.

For use in the apparatus it is especially advantageous if the individual adhesive tape sections are arranged in the form of rectangles on the backing material web. It is further very advantageous if these rectangles are arranged on the backing material web without any distance between the individual adhesive tape sections.

The production of such adhesive tape sections on a backing material web without any distance between them is often very difficult owing to the coalescence of the adhesive.

With further preference, therefore, a backing material web can be used on which there are arranged diecuts composed of a pressure-sensitive adhesive which possesses anisotropic properties.

In the course of the production, further processing, or later stressing of polymers or polymer compositions it is possible for high degrees of orientation of the macromolecules in preferred directions in the overall polymer assembly to form; as result of this orientation, which can also be induced deliberately, it is possible to steer the properties of the corresponding polymers and to improve them in respect of desired applications. Anisotropically oriented pressure-sensitive adhesives possess the tendency to return to the initial state following stretching in a given direction, as a result of their “entropy-elastic” behaviour.

Suitable for use in principle are all pressure-sensitive adhesives which exhibit an orientation, examples being those based on natural and synthetic rubbers such as butyl rubber, neoprene, butadiene-acrylonitrile, styrene-butadiene-styrene and styrene-isoprene-styrene copolymers, and also those based on linear polyesters and copolyesters, polyurethanes, polysiloxane elastomers, those based on straight acrylates, but especially polyacrylate-based anisotropic pressure-sensitive adhesives.

Such anisotropically oriented acrylate pressure-sensitive adhesives, in the form of a layer after punching and/or cutting operations, exhibit a retreat of the pressure-sensitive adhesive layer at the cut and punched edge, which is utilized for the diecutting of punched shapes which do not coalesce.

One advantageous development uses a pressure-sensitive adhesive
which is obtainable by free-radical polymerization,
which is composed to the extent of at least 65% by weight of at least one acrylic monomer from the group of compounds of the following general formula: 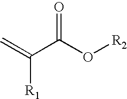
where R₁=H or CH₃ and the radical R₂═H or CH₃ or is selected from the group of branched and unbranched, saturated alkyl groups having 2 to 20 carbon atoms, preferably 4 to 9 carbon atoms,
for which the average molecular weight of the pressure-sensitive adhesive is at least 650 000,
and which, when applied to a backing, possesses a preferential direction, the refractive index measured in the preferential direction, n_{MD}, being greater than the refractive index measured in a direction perpendicular to the preferential direction, n_{CD}, and where the difference Δn=n_{MD}−n_{CD} amounts to at least 1×10⁻⁵.

Non-exclusive examples of alkyl groups which may find preferred application for the radical R₂ include butyl, pentyl, hexyl, heptyl, octyl, isooctyl, 2-methylheptyl, 2-ethylhexyl, nonyl, decyl, dodecyl, lauryl, or stearyl (meth)acrylate or (meth)acrylic acid.

The diecutting procedure is also excellent when using a pressure-sensitive adhesive based to an extent of up to 35% by weight on comonomers in the form of vinyl compounds, especially one or more vinyl compounds selected from the following group: vinyl esters, vinyl halides, vinylidene halides, nitriles of ethylenically unsaturated hydrocarbons.

For the purposes of this utility, acrylic compounds with functional groups are also embraced by the term “vinyl compound”. Vinyl compounds of this kind containing functional groups are maleic anhydride, styrene, styrenic compounds, vinyl acetate, (meth)acrylamides, N-substituted (meth)acrylamides, β-acryloyloxypropionic acid, vinylacetic acid, fumaric acid, crotonic acid, aconitic acid, dimethylacrylic acid, trichloroacrylic acid, itaconic acid, vinyl acetate, hydroxyalkyl (meth)acrylate, amino-containing (meth)acrylates, hydroxyl-containing (meth)acrylates, especially 2-hydroxyethyl (meth)acrylate, 2-hydroxypropyl (meth)acrylate, and/or 4-hydroxybutyl (meth)acrylate, and double-bond-functionalized photoinitiators; the above listing is only exemplary and not exhaustive.

For the pressure-sensitive adhesives it is especially advantageous if the composition of the corresponding monomers is chosen such that the resultant adhesives possess pressure-sensitive adhesion properties in accordance with D. Satas [Handbook of Pressure Sensitive Adhesive Technology, 1989, VAN NOSTRAND REINHOLD, New York]. For this purpose the glass transition temperature of the acrylate pressure-sensitive adhesive should be situated, for example, below 25° C.

The pressure-sensitive adhesives employed for the utility, particularly those of polyacrylate pressure-sensitive adhesives praised above for their advantage, are prepared preferably by a free-radically initiated polymerization. One process very suitable for this purpose is distinguished by the following steps:
polymerization of a mixture comprising at least one vinyl-, acryloyl- or methacryloyl-based monomer or a combination of these monomers, the average molecular weight of the resultant polymers being situated above 650 000,
subsequent extrusion coating of the polymer composition,
subsequent crosslinking of the polymer composition on the backing by irradiation with electron beams.

Extrusion coating takes place preferably through an extrusion die. The extrusion dies used may come from one of the three following categories: T-dies, fishtail dies, and coat hanger dies. The individual types differ in the design of their flow channel. For the preparation of oriented acrylate pressure-sensitive adhesives it is particularly preferred to carry out coating onto a backing using a coat hanger die, specifically such that a layer of polymer on the backing is formed by a movement of die relative to backing.

The period between coating and crosslinking is advantageously very short, preferably no greater than 10 s.

By virtue of the shaping of the acrylate hotmelt in the coat hanger die and its emergence from the die with a defined film thickness, as a result of the stretching of the film of pressure-sensitive adhesive as it transfers to the backing material, to give a thinner film thickness, and as a result of the subsequent inline crosslinking, the orientation is obtained.

The free radical polymerization can be conducted in the presence of an organic solvent or in the presence of water, or in mixtures of organic solvents and water, or in bulk. It is preferred to use as little solvent as possible. Depending on conversion and temperature, the polymerization time amounts to between 6 and 48 h.

In the case of solution polymerization the solvents used are preferably esters of saturated carboxylic acids (such as ethyl acetate), aliphatic hydrocarbons (such as n-hexane or n-heptane), ketones (such as acetone or methyl ethyl ketone), special-boiling-point spirit, or mixtures of these solvents. For polymerization in aqueous media or in mixtures of organic and aqueous solvents, the emulsifiers and stabilizers known to the person skilled in the art for this purpose are added to the polymerization. Polymerization initiators used are customary radical-forming compounds such as peroxides, azo compounds and peroxosulphates, for example. Initiator mixtures, too, can be used. During the polymerization it is possible to use further regulators to lower the molecular weight and to reduce the polydispersity. As polymerization regulators it is possible, for example, to use alcohols and ethers. The molecular weight of the acrylate pressure-sensitive adhesives lies advantageously between 650 000 and 2 000 000 g/mol, more preferably between 700 000 and 1 000 000 g/mol.

In a further procedure the polymerization is carried out in polymerization reactors which are generally provided with a stirrer, two or more feed vessels, reflux condenser, heating and cooling and are equipped for operation under an N₂ atmosphere and superatmospheric pressure.

Following the polymerization in solvent the polymerization medium can be removed under reduced pressure, this operation being conducted at elevated temperatures, in the range from 80 to 150° C., for example. The polymers can then be used in the solvent-free state, in particular as hotmelt pressure-sensitive adhesives [hotmelt PSAs]. In some cases it is also advantageous to prepare the polymers of the invention without solvent.

To prepare the acrylate PSAs the polymers can be given a conventional modification. For example, tackifying resins, such as terpene, terpene-phenolic, C₅, C₉ and C₅/C₉ hydrocarbon, pinene and indene resins or rosins, alone or in combination with one another, can be added. It is also possible, furthermore, to use plasticizers, various fillers (for example fibres, carbon black, zinc oxide, titanium dioxide, solid microbeads, solid or hollow glass beads, silica, silicates, chalk, blocking-free isocyanates, etc.), aging inhibitors, light stabilizers, ozone protectants, fatty acids, nucleating agents, expandants and/or accelerants as additives. Crosslinkers and crosslinking promoters can also be mixed in. Examples of suitable crosslinkers for electron bean crosslinking are difunctional or polyfunctional acrylates, difunctional or polyfunctional isocyanates or difunctional or polyfunctional epoxides.

The acrylate hotmelts, as they are or in the form of blends, are coated onto the backing material through a die with a variable slot width and then are cured on the backing using electron beams. In inline operation, crosslinking takes place immediately after the pressure-sensitive adhesive has been applied to the backing.

The combination of the apparatus and the backing material web affords a multiplicity of advantages which as such could not have been foreseen.

The dispensing of the adhesive tape sections is not accompanied by any loss of time owing to the removal of a liner, and involves less waste. Different sizes of the adhesive tape sections—adhered in different numbers—make it possible, so to speak, to “dose” the required amount of adhesive tape.

The apparatus preferably uses double-sided self-adhesive tape sections which are disposed gaplessly on the backing material web: for example, a double-sided self-adhesive tape 15 mm wide with a transverse separation every 15 mm.

In other words, a stretch of adhesive of, for example, 90 mm is replaced by 6 15 mm adhesive tape sections. Other, arbitrary dimensions are likewise conceivable.

By virtue of the adhesive tape sections 15 mm in length it is possible for even an inherently rigid double-sided self-adhesive tape with carrier to be bonded in curves with the assistance of the apparatus of the invention.

The apparatus features adjustable start and end marking, enabling the user to position any desired number of adhesive tape sections on the substrate.

All functional elements are arranged in such a way that the dispensing operation can be accomplished not just in the normal, traction mode, but also, preferably, by means of a pushing movement.

To summarize, the method of the invention offers the following advantages:

The method is used for fixing flat ribbon cables (FFC laminated cable systems) to surfaces, especially surfaces of passenger cars, in such a way that the cable system can be applied to the passenger car component in a single workstep with high positional precision.

For this purpose, a special gun, which can also be mounted on a robot, applies a tape, equipped with double-sided adhesive tape sections, directly to the substrate, the roof lining for example, and the gun automatically rolls up the tape.

The adhesive tape allows adhesive pieces lying in close succession to be positioned on a roll in such a way that, on unrolling by way of a specific applicator, these pieces automatically cross to/remain adhering on the surface (substrate) of the passenger car component. For that purpose, the release paper is provided in a special layer whose repellency differs on either side, allowing a continuous, rapid application/transfer of the sections. The gun (apparatus) allows flexible application: that is, it can be placed at the site of intended application and easily lifted off at the point where application is to end. The process operates without cutters or blades, so that there is no possibility of injury to the operative during the job. This method is also advantageous since there is no need during application for any cutters or a blade, which might damage the laminated cable during cutting or, by introducing a notch, might make it unusable, and so there are no inconvenient failures in electrical function.

Parallel to this, a flat ribbon cable or system of flat ribbon cables in the fashion of a cable loom is inserted into a holding means which independently carries the system for a short period of time, through adjustable clamping. The grid carries specially prepared bending zones on which the FFC can form curves/elbows in a positionally correct fashion.

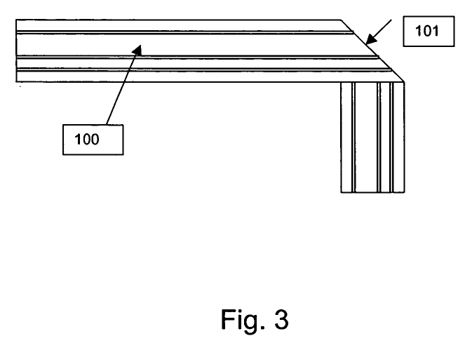

The holding grid has the same geometry as the position of the laminated cable on the passenger car moulding; that is, where the laminated cable is subsequently to run straight over a length, for example, of 80 cm and then be bent by 90°, followed by a further 40 cm straight, and to be bonded in that geometry on the passenger car moulding, the assembly grid also has this (mirror-image) geometry (see FIG. 3).

The construction of the assembly grid is such that it is able to accommodate all changes in direction. In the case of FFC laminated cable, a change in direction can be realized only by folding or bending. The holding means likewise allows such curve zones to be accommodated, these zones being suitable for folding or bending of the laminated cable during assembly. The particular advantage of this holding means is that, in the course of assembly, the correct position with all its curves (angles) can be presented in positionally correct fashion even before the FFC laminate system is swivelled into its final bond site on the passenger car component.

The mount is swivelled onto the roof liner part in such a way that the flat ribbon cable lies directly on the roof liner, in positionally correct fashion. The mount is preferably equipped with a spring-controlled pressing means, which exerts the required pressure, so that in one back-and-forth movement the flat ribbon cable is firmly joined to the roof lining.

The following disadvantages are avoided by this:
no inconvenient pre-application of adhesive tapes to flat ribbon cable
no time-consuming removal of release paper from the adhesive tapes before the flat ribbon cable can be mounted on the roof liner
no time-consuming pressing of the flat ribbon cable onto the underlying surface, especially when this surface is rough and absorbent (strike-in of the adhesive into the surface)
no follow-up of the flat ribbon cable on the roof lining during assembly; no mis-positioning, which often involves rebonding/corrective bonding
no subsequent correction of the bond, i.e. possible removal of a bond which has not been positioned correctly to millimetre precision

The following advantages are in evidence:
automatic pressing of the flat ribbon cable into the surface of the roof lining
automatable, robot-compatible

Particularly advantageous embodiments of the apparatus are illustrated with reference to the below-described figures, without wishing thereby to restrict the invention unnecessarily. Specifically

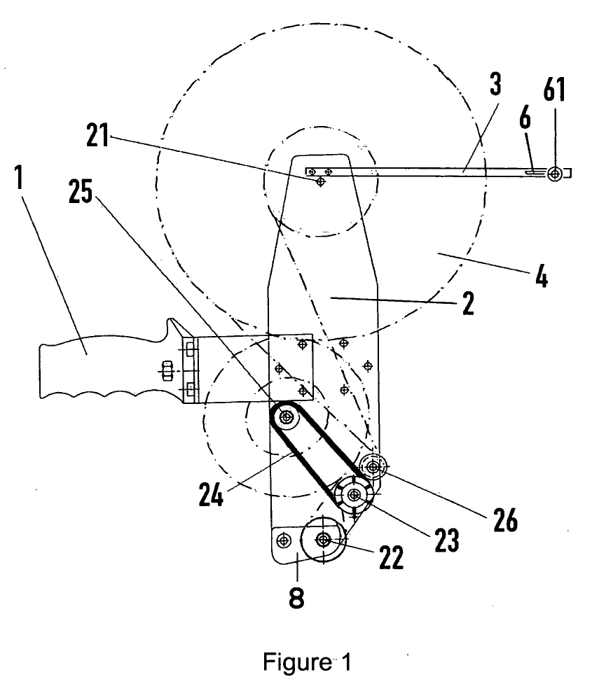

FIG. 1 shows the apparatus with a roll of the backing material web, in one especially advantageous embodiment,

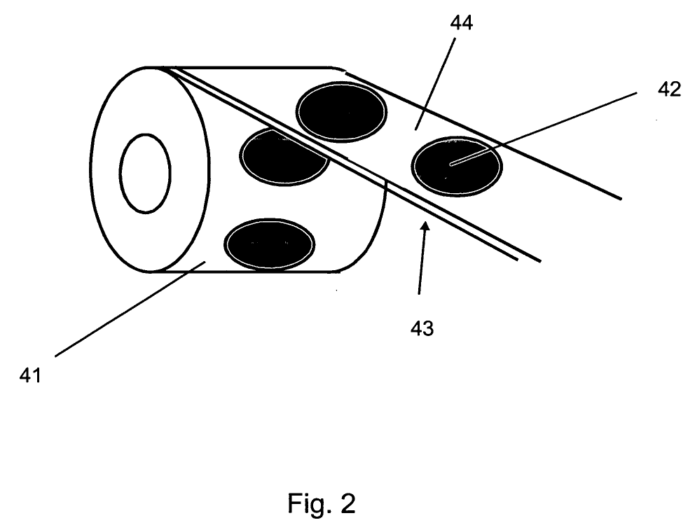

FIG. 2 show a roll of the backing material web with adhesive tape sections,

FIG. 3 shows the holding grid, and

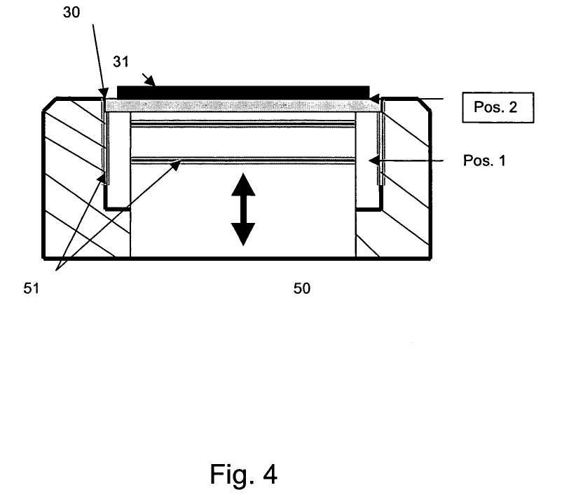

FIG. 4 shows the assembly apparatus with a movable base plate.

FIG. 1 shows the apparatus for unrolling a backing material web 41, present on a roll 4, with double-sided adhesive tape sections 42.

The apparatus is composed of a number of individual components.

The central component is the base plate 2, which serves to accommodate all other components, such as a handle 1 which is screwed to the base plate 2.

Simply changing the position of the handle 1 allows the apparatus to be moved in traction and, in particular, in a pushing movement during the dispensing operation. Preferably the apparatus is pushed, since ergonomically speaking a greater pressing force, which is advantageous for pressure-sensitive self-adhesive compositions, is much easier to apply in the case of a pushing movement.

A rotatably mounted receiver 21 for the roll 4 of backing material web 41 is then provided on the base plate 2.

Also present in rotatable mounting on the base plate 2 is a pressure roller 22 which during the dispensing operation brings the backing material web 41 with the adhesive tape sections 42 into contact with the substrate and which, via 21 for the roll 4, is guided in such a way that the adhesive tape sections 42, during the dispensing operation, are dispensed from the backing material web 41 onto the substrate.

The material and diameter of the pressure roller 22 are such that, on the one hand, a sufficient applied pressure is ensured for the bonding of the self-adhesive tape sections 42 and, on the other hand, the backing material web 41 can be removed readily from the double-sided adhesive tape sections 42 in the course of dispensing. In this case the roller 22 is attuned specifically to the properties of the double-sided adhesive tape sections 42 on the backing material web 41.

By way of a drive roller 23 mounted rotatably on the base plate 2 the backing material web 41 with the adhesive tape sections 42 is guided in such a way that the drive roller 23 rotates synchronously to the speed of the backing material web 41.

The drive roller 23 is disposed between the receiver 21 for the roll 4 of backing material web 41 and the pressure roller 22.

So that the backing material web 41 exhibits a large angle of wrap around the drive roller, a guide roller 26 is disposed between the receiver 21 for the roll 4 of backing material web 41 and the drive roller 23, and in turn is surrounded by the backing material web 41.

Located on the base plate 2, finally, is a rotatably mounted receiving roller 25, which receives the backing material web 41 after the adhesive tape sections 42 have been dispensed and which is set in rotation by the movement of the drive roller 23, in particular by way of a belt 24.

Provided on the holding means 2, on a fixable axle 3, is an adjustable positioning aid 6, in the form of a rotatably mounted shaft 61 which can be fixed by screwing and via which the backing material web 41 is guided from the receiver 21 for the roll 4 of the backing material web 41 in the direction of drive roller 23.

One side of the pressure roller 22 is fixed to the base plate 2, and on its other side it carries a counterplate 8. In the case of the apparatus 100 which is pushed during the dispensing operation the counterplate 8 and the base plate 2 are of prolonged design in the direction of the handle 1. In terms of their shape, the counterplate 8 and the base plate 2 are harmonized with the pressure roller 22 and the lever arm of the handle 1 in such a way that at the end of the dispensing operation the entire apparatus can easily be tipped by the user about the fulcrum which results from this geometry. As a result of this turning movement it is always possible, in conjunction with the positioning aid 6, on the one hand to dispense the last adhesive tape section 42 reliably, i.e. to transfer it from the backing material web 41 to the substrate, while on the other hand the next adhesive tape section 42, not to be applied until later, is still held securely on the backing material web 41.

The whole apparatus is harmonized in such a way that with either an empty or a full receiving roller 25 there is no adverse effect on the positioning accuracy of the double-sided self-adhesive tape sections 42. This relates in particular to the transmission ratio of the belt drive between the rollers 23 and 25.

In accordance with FIG. 2, the backing material web 41 is wound into a roll in the form of an Archimedean spiral. On the backing material web 41 the individual adhesive tape sections 42, here in the form of circles, are arranged at regular intervals.

The backing material web 41 has different anti-adhesive coatings 43, 44. The anti-adhesive coating 43 located on the bottom face of the backing material web 41 has a higher degree of repellency than the anti-adhesive coating 44 located on the top face of the backing material web 41.

In accordance with FIG. 3, the holding grid has the same geometry as the position of the laminated cable on the passenger car moulding; that is, where the laminated cable is subsequently to run straight over a length, for example, of 80 cm and then be bent by 90° (bending point 101), followed by a further 40 cm straight, and to be bonded in that geometry on the passenger car moulding, the assembly grid also has this (mirror-image) geometry (see FIG. 3).

FIG. 4 shows the assembly apparatus with a movable base plate 50, which allows the laminated cable harness 30 to be loaded in position 1 (position with base plate 50 down); while it swivels up into the bonding position above the passenger car moulding, the base plate 50 moves into position 2 (position with base plate 50 up), which allows pressing. In this case the adhesive force of the adhesive tape 31 is set such that the laminated cable harness 30, after first contact in its bonding position, is released automatically from its mounting, since the adhesion to the substrate exceeds the holding force in the assembly apparatus.

1. A method of bonding at least one flat ribbon cable adhesively to a substrate, which comprises:
a) inserting the flat ribbon cable into a mount to which the flat ribbon cable is temporarily fixed,
b) applying at least one double-sided adhesive tape section to the flat ribbon cables,
c) moving the flat ribbon cable and the substrate relative to one another, and
d) adhesively bonding the at least one flat ribbon cable to the substrate by the at least one double-sided adhesive tape section, so that when the mount is removed from the substrate the flat ribbon cable is detached from the mount.

2. Method according to claim 1, wherein
the adhesive bonding of the at least one double-sided adhesive tape section to the flat ribbon cable takes place by means of an apparatus for unrolling a backing material web, present on a roll, with the at least one double-sided adhesive tape section, said apparatus comprising the following components:
a) a handle fitted to a base plate,
b) a receiver mounted rotatably on the base plate and intended for the roll of backing material web,
c) a pressure roller which is mounted rotatably on the base plate and which during a dispensing operation brings the backing material web with the at least one double-sided adhesive tape section into contact with the substrate and, via for the roll, is guided in such a way that the at least one double-sided adhesive tape section is dispensed onto the substrate from the backing material web during the dispensing operation,
d) a drive roller which is mounted rotatably on the base plate and via which the backing material web with the at least one double-sided adhesive tape section is guided in such a way that the drive roller rotates synchronously with respect to the speed of the backing material web,
e) a receiver roller which is mounted rotatably on the base plate and which receives the backing material web after the at least one double-sided adhesive tape section has been dispensed, and which, optionally, is set in rotation via a belt by the movement of the drive roller.

3. Method according to claim 2, wherein the drive roller is disposed between the receiver for the roll of backing material web and the pressure roller and/or a guide roller is disposed between the receiver for the roll of backing material web and the drive roller.

4. Method according to claim 2, wherein on an axle which can be fixed on the handle there is an adjustable positioning aid, optionally, in the form of a rotatably mounted shaft which can be fixed by screwing, via which the backing material web is guided from the receiver for the roll of backing material web in the direction of drive roller.

5. Method according to claim 2, wherein the handle and all other components can be mounted in mirror-image form on the base plate.

6. Method according to claim 2, wherein in the receiver for the roll of backing material web there is an adjustable brake, which is, optionally, a friction brake.

7. Method according to claim 2, wherein one side of the pressure roller is fixed on the base plate and another side carries a counterplate, the counterplate and the base plate being of prolonged design in the direction of the handle in the event the apparatus is designed to be pushed during the dispensing operation.

8. Method according to claim 2, wherein the apparatus is guided by a robot, so that the at least one double-sided adhesive tape section is applied to the flat ribbon cable at a precisely predetermined location.

9. Method according to claim 1, wherein the mount is designed in the form of a channel having side walls that bracket the edges of the flat ribbon cable, so that the flat ribbon cable is fixed mechanically in the channel.

10. Method according to claim 9, wherein the height of the side walls of the channel corresponds approximately to the sum of the thickness of the flat ribbon cable and of the at least one double-sided adhesive tape section.

11. Method according to claim 9, wherein the channel is equipped with an adhesive tape coating to which the flat ribbon cable is laminated, and the laminated cable is incapable of moving in a lengthwise direction in the channel.

12. Method according to claim 11, wherein the adhesive tape coating is a double-sided adhesive tape coating.

13. Method according to claim 1, wherein the substrate is an interior decorative component of a passenger car.

14. Method according to claim 13, wherein the interior decorative component of a passenger car is selected from the group consisting of the roof lining, door side part and boot lid.
